(19) United States
(12) Patent Application Publication
(10) Pub. No.: US 2026/0003930 A1
(43) Pub. Date: Jan. 1, 2026

(54) OPTIMIZATION METHOD AND OPTIMIZATION SYSTEM OF REGRESSION MODEL AND COMPUTER READABLE RECORDING MEDIUM

(71) Applicant: NATIONAL TSING HUA UNIVERSITY, HSINCHU (TW)

(72) Inventor: Wei-Chang YEH, Hsinchu (TW)

(21) Appl. No.: 19/023,197

(22) Filed: Jan. 15, 2025

(30) Foreign Application Priority Data
Jun. 28, 2024 (TW) 113124222

(51) Int. Cl. G06F 17/12

(52) U.S. Cl. CPC G06F 17/12

(57) ABSTRACT

An optimization method of a regression model includes generating a parameter set according to a Simplification Swarm Optimization rule, the parameter set includes a plurality of threshold values and a plurality of model codes, the model codes correspond to a plurality of the regression models, and a plurality of types of the regression models are different from each other; arranging the threshold values; dividing a plurality of data of a dataset into a plurality of groups sequentially according to the threshold values; calculating the data of the groups according to the model codes corresponding to the groups to generate a predicting result and a fitness value of the predicting result; updating a best fitness value in a database according to the fitness value corresponding to the parameter set; and repeating the above steps until a number of the parameter sets being equal to a predetermined value.

### RELATED APPLICATIONS

This application claims priority to Taiwan Application Serial Number 113124222, filed Jun. 28, 2024, which is herein incorporated by reference.

### BACKGROUND

### Technical Field

The present disclosure relates to an optimization method, an optimization system and a computer readable recording medium. More particularly, the present disclosure relates to an optimization method and an optimization system of a regression model and a computer readable recording medium.

### Description of Related Art

Machine learning models can recognize the data in the dataset to analyze the trend of the data, generate a predicting result according to the analyzed data, or classified with the data. The machine learning models include supervised learning model, semi-supervised learning model and unsupervised learning model, and the regression models of the supervised learning model are simple, flexible, stable and fault tolerant. The regression models can use to predict continuous values such as temperature or amount.

Moreover, the classification model of the supervised learning model can predict a boundary value of the predicting result according to the threshold value, the threshold value is important to the classification model. For instance, when an incident probability value of an event is calculated by a model, the model can determine that the event will incident or not by the probability value is bigger than the threshold or not.

Therefore, an optimization method and an optimization system of a regression model and a computer readable recording medium which can apply the threshold value to the regression model, and reduce the residual are commercially desirable.

### SUMMARY

According to one aspect of the present disclosure, an optimization method of a regression model includes driving a processor to generate a parameter set according to a Simplification Swarm Optimization rule, the parameter set includes a plurality of threshold values and a plurality of model codes, the model codes correspond to a plurality of the regression models, and a plurality of types of the regression models are different from each other; driving the processor to arrange the threshold values according to an increment sequence; driving the processor to divide a plurality of data of a dataset into a plurality of groups sequentially according to the threshold values, the groups correspond to the model codes, respectively; driving the processor to calculate the data of the groups according to the model codes corresponding to the groups to generate a predicting result and a fitness value of the predicting result; driving the processor to update a best fitness value in a database according to the fitness value corresponding to the parameter set; and driving the processor to repeat the above steps until a number of a plurality of the parameter sets being equal to a predetermined value.

According to another aspect of the present disclosure, an optimization system of a regression model includes a database and a processor. The database includes a Simplification Swarm Optimization rule, a plurality of the regression models, a dataset and a best fitness value. The processor is signally connected to the database, and configured to implement an optimization method of the regression model. The optimization method of the regression model includes generating a parameter set according to the Simplification Swarm Optimization rule, the parameter set includes a plurality of threshold values and a plurality of model codes, the model codes correspond to the regression models, and a plurality of types of the regression models are different from each other; arranging the threshold values according to an increment sequence; dividing a plurality of data of the dataset into a plurality of groups sequentially according to the threshold values, the groups correspond to the model codes, respectively; calculating the data of the groups according to the model codes corresponding to the groups to generate a predicting result and a fitness value of the predicting result; updating the best fitness value according to the fitness value corresponding to the parameter set; and repeating the above steps until a number of a plurality of the parameter sets being equal to a predetermined value.

According to further another aspect of the present disclosure, a computer readable recording medium stores a program for a processor, to execute an optimization method of a regression model. The optimization method of the regression model includes driving the processor to generate a parameter set according to a Simplification Swarm Optimization rule, the parameter set includes a plurality of threshold values and a plurality of model codes, the model codes correspond to a plurality of the regression models, and a plurality of types of the regression models are different from each other; driving the processor to arrange the threshold values according to an increment sequence; driving the processor to divide a plurality of data of a dataset into a plurality of groups sequentially according to the threshold values, the groups correspond to the model codes, respectively; driving the processor to calculate the data of the groups according to the model codes corresponding to the groups to generate a predicting result and a fitness value of the predicting result; driving the processor to update a best fitness value in a database according to the fitness value corresponding to the parameter set; and driving the processor to repeat the above steps until a number of a plurality of the parameter sets being equal to a predetermined value.

### BRIEF DESCRIPTION OF THE DRAWINGS

The present disclosure can be more fully understood by reading the following detailed description of the embodiment, with reference made to the accompanying drawings as follows:

FIG. 1 shows a flow chart of an optimization method of a regression model according to a first embodiment of the present disclosure.

FIG. 2 shows a block diagram of an optimization system of a regression model according to a second embodiment of the present disclosure.

FIG. 3 shows a schematic view of a step of updating the best fitness value of the optimization method of the regression model of FIG. 1.

FIG. 4 shows a flow chart of an optimization method of a regression model according to a third embodiment of the present disclosure.

FIG. 5 shows a comparative schematic view between an actual value and the predicting result of the optimization method of the regression model of FIG. 4.

FIG. 6 shows another comparative schematic view between an actual value and the predicting result of the optimization method of the regression model of FIG. 4.

FIG. 7 shows further another comparative schematic view between an actual value and the predicting result of the optimization method of the regression model of FIG. 4.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

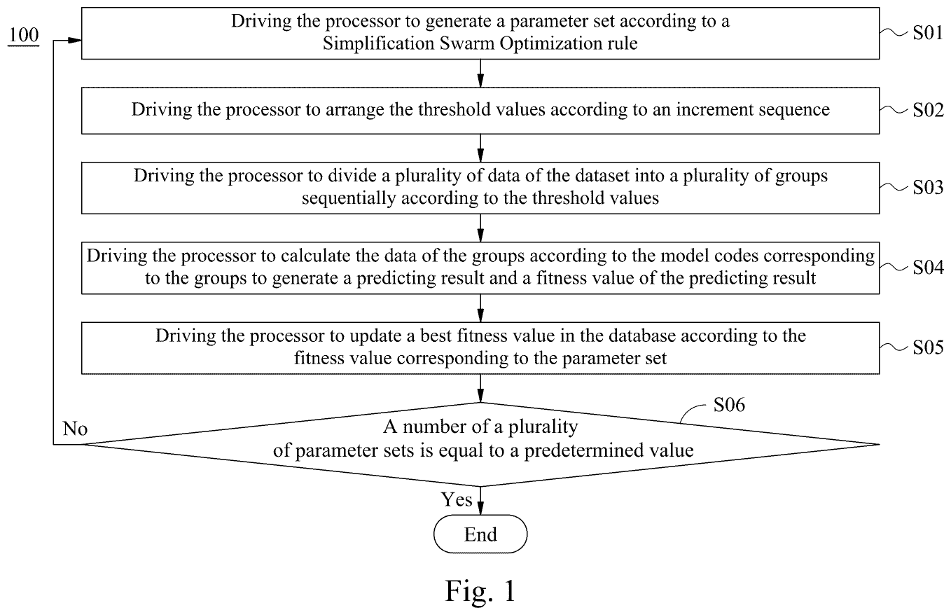

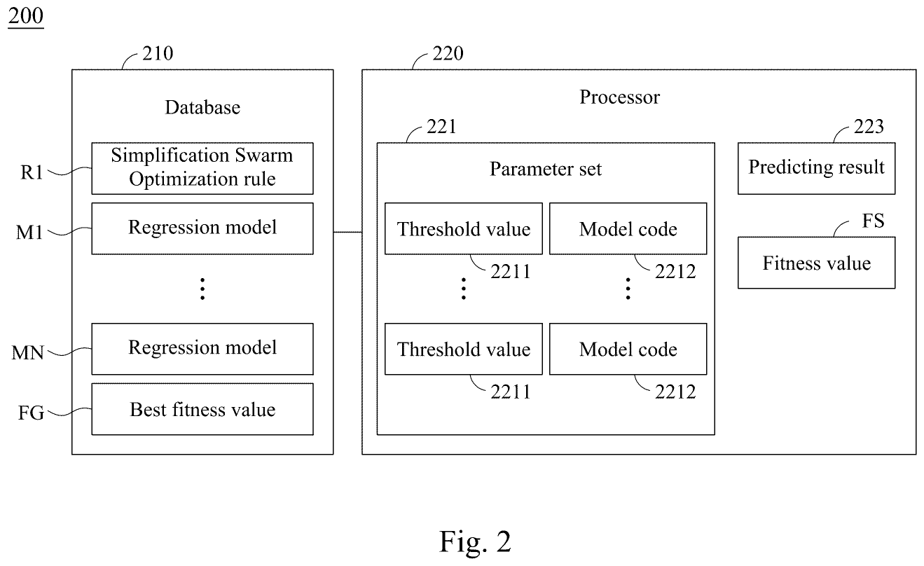

Please refer to FIG. 1 and FIG. 2. FIG. 1 shows a flow chart of an optimization method 100 of a regression model according to a first embodiment of the present disclosure. FIG. 2 shows a block diagram of an optimization system 200 of the regression model according to a second embodiment of the present disclosure. In FIG. 2, the optimization system 200 of the regression model includes a database 210 and a processor 220. The database 210 includes a Simplification Swarm Optimization rule R1, a plurality of the regression models M1-MN, a dataset and a best fitness value FG. The processor 220 is signally connected to the database 210, and configured to implement the optimization method 100 of the regression model, but the present disclosure is not limited thereto. In detail, the optimization method 100 of the regression model includes the steps S01, S02, S03, S04, S05, S06. The step S01 includes driving the processor 220 to generate a parameter set 221 according to the Simplification Swarm Optimization rule R1. The parameter set 221 includes a plurality of threshold values 2211 and a plurality of model codes 2212, the model codes 2212 correspond to the regression models M1-MN, and a plurality of types of the regression models M1-MN are different from each other. The step S02 includes driving the processor 220 to arrange the threshold values 2211 according to an increment sequence. The step S03 includes driving the processor 220 to divide a plurality of data of the dataset into a plurality of groups sequentially according to the threshold values 2211. The groups correspond to the model codes 2212, respectively. The step S04 includes driving the processor 220 to calculate the data of the groups according to the model codes 2212 corresponding to the groups to generate a predicting result 223 and a fitness value FS of the predicting result 223. The step S05 includes driving the processor 220 to update a best fitness value FG in the database 210 according to the fitness value FS corresponding to the parameter set 221. The step S06 includes driving the processor 220 to repeat the above steps S01, S02, S03, S04, S05 until a number of a plurality of the parameter sets 221 being equal to a predetermined value.

Specifically, the database 210 includes a Random Access Memory (RAM) capable to store information and instruction for the processor 220 to process or other dynamic storing device, the processor 220 can include any type of processor, microprocessor, but the present disclosure is not limited thereto. The regression models M1-MN can include one of a Linear Regression model, a Ridge Regression model, a Least Absolute Shrinkage and Selection Operator (LASSO) regression model, a Decision Tree regression model, a Gradient Boosting regression model, a random forest regression model, an Adaptive Boosting regression model, a Bagging regression model, an Extra Trees regression model, an extreme Gradient Boosting (XGBoost) regression model, a Support Vector Regression (SVR) model, a Nu-SVR regression model, a Linear SVM model, a K-nearest Neighbors regression model and an Artificial Neural Network (ANN). In the present embodiment, the processor 220 is installed a 64-bit Windows 10 operating system and run on open-source software Python and Scikit Learn package to perform the regression models M1-MN, and the present disclosure is not limited thereto.

The Simplification Swarm Optimization rule R1 is configured to generate a parameter set 221 of the present iteration, and the parameter set 221 includes a plurality of threshold values 2211 and a plurality of model codes 2212 corresponding to each the threshold values 2211. The Simplification Swarm Optimization rule R1 is satisfied the following formulas (1) and (2):

$${t}_{i , j} = \{ \begin{matrix}{g}_{t , j} , if {ρ}_{t , j} ∈ [ 0 , {C}_{g} ) \\ {p}_{t , i , j} , if {ρ}_{t , j} ∈ [ {C}_{g} , {C}_{p} ) \\ {t}_{i , j} , if {ρ}_{t , j} ∈ [ {C}_{p} , {C}_{w} ) \\ t , if {ρ}_{t , j} ∈ [ {C}_{w} , 1 ]\end{matrix} ; and \qquad ( 1 )$$

$${m}_{i , j} = \{ \begin{matrix}{g}_{m , j} , if {ρ}_{m , j} ∈ [ 0 , {C}_{g} ) \\ {p}_{m , i , j} , if {ρ}_{m , j} ∈ [ {C}_{g} , {C}_{p} ) \\ {m}_{m , j} , if {ρ}_{m , j} ∈ [ {C}_{p} , {C}_{w} ) \\ m , if {ρ}_{m , j} ∈ [ {C}_{w} , 1 ]\end{matrix} . \qquad ( 2 )$$

t_{i,j} is a j-th threshold value 2211 of an i-th parameter set 221, g_{t,j} is a j-th threshold value 2211 of a global best parameter set, p_{t,i,j} is a j-th threshold value 2211 of a partial best parameter set, t is a random value, β_{t,j} and ρ_{m,j} are two random parameters between 0 and 1, C_{g}, Cₚ, C_{w} are a first parameter, a second parameter and a third parameter, respectively, m_{i,j} is a j-th model code 2212 of the i-th parameter set, g_{m,j} is a j-th model code 2212 of the global best parameter set, p_{m,i,j} is a j-th model code 2212 of the partial best parameter set, m is another random value.

Please refer to Table 1, i is 9, X_{g,j} represents the ninth parameter set 221, t_{g,j} represents a j-th threshold value 2211 of the ninth parameter set 221, m_{g,j} represents the j-th model code 2212 of the ninth parameter set 221, g represents the present global best parameter set, P_{g} represents the present partial best parameter set. The first parameter C_{g} is 0.4, the second parameter Cₚ is 0.7, and the third parameter C_{w} is 0.9. The present parameter set 221 (i.e., X_{g,j}) is [(21,135,135,196,205), (8,7,6,14,8)], the random parameter βⱼ is [(0.15,0.56,0.48,0.32,0), (0.3,0.69,0.51,0.81,0.92)], the partial best parameter set P_{g} in the present iteration is [(93,98, 154, 163,205), (5,13,13,13,9)], the global best parameter set is [(99,100,117,168,205), (3,7,4,5,8)]. The Simplification Swarm Optimization rule R1 updates the threshold value 2211 and the model code 2212 in the parameter set 221 according to a value relationship between the random parameter ρⱼ and the first parameter, the second parameter and the third parameter. In the Table 1, the first random parameter ρ₁ is 0.15, and is smaller than the first parameter, that is, the updated threshold value t_{g,1} is the first value (99) in the global best parameter set. The second random parameter ρ₂ is 0.56, and is between the first parameter and the second parameter, that is, the updated threshold value t_{g,2} is the second value (98) in the partial best parameter set P_{g}. The third random parameter ρ₃ is 0.48, and is between the first parameter and the second parameter, that is, the updated threshold value t_{g,3} is the third value (154) in the partial best parameter set P_{g}. The fourth random parameter ρ₄ is 0.32, and is smaller than the first parameter, that is, the updated threshold value t_{g,4} is the fourth value (168) in the global best parameter set. The fifth random parameter ρ₅ is 0, and is smaller than the first parameter, that is, the updated threshold value t_{g,5} is the fifth value (205) in the global best parameter set. The threshold values 2211 are for dividing the data in the dataset into a plurality of groups, which are not overlapped, the fifth threshold value 2211 in each of the parameter sets 221 is equal to total amount of the dataset. The first random parameter ρ₁ is 0.3, and is smaller than the first parameter, that is, the updated model code m_{g,1} is the first model code (3) in the global best parameter set. The second random parameter ρ₂ is 0.69, and is between the first parameter and the second parameter, that is, the updated model code m_{g,2} is the second model code (13) in the partial best parameter set P_{g}. The third random parameter ρ₃ is 0.51, and is between the first parameter and the second parameter, that is, the updated model code m_{g,3} is the third model code (13) in the partial best parameter set. The fourth random parameter ρ₄ is 0.81, and is between the second parameter and the third parameter, that is, the updated model code m_{g,4} is the fourth model code (14) in the ninth parameter set of the present iteration. The fifth random parameter ρ₅ is 0.92, and is bigger than the third parameter, that is, the updated model code m_{g,5} is a random value (5).

TABLE 1

| | t_{9, j} | | | | | m_{9, j} | | | | |
|---|---|---|---|---|---|---|---|---|---|---|
| j | 1 | 2 | 3 | 4 | 5 | 1 | 2 | 3 | 4 | 5 |
| X_{9, j} | 21 | 135 | 135 | 196 | 205 | 8 | 7 | 6 | 14 | 8 |
| P₉ | 93 | 98 | 154 | 163 | 205 | 5 | 13 | 13 | 13 | 9 |
| g | 99 | 100 | 117 | 168 | 205 | 3 | 7 | 4 | 5 | 8 |
| ρⱼ | 0.15 | 0.56 | 0.48 | 0.32 | 0 | 0.3 | 0.69 | 0.51 | 0.81 | 0.92 |
| Updating X_{9, j} | 99 | 98 | 154 | 168 | 205 | 3 | 13 | 13 | 14 | 5 |

The parameter set 221 generated by the step S01 can include threshold values t_{i,j} and model codes m_{i,j}, the threshold values t_{g} of the ninth parameter set 221 updated according to the Simplification Swarm Optimization rule R1 are (99,98,154, 168,205), the model codes m_{i,j} of the ninth parameter set 221 updated according to the Simplification Swarm Optimization rule R1 are (3,13,13,14,5). The model codes 2212 correspond to a plurality of regression models M1-MN with different types. The step S02 is performed to adjust the threshold values t_{g} according to the increment sequence from small value to large value as (98,99,154,168,205).

The step S03 is performed to divide the data in the dataset into different intervals according to the adjusted threshold values 2211. Take the adjusted threshold values to as an example, the dataset includes 205 pieces of data, the dataset is divided into five groups, the five groups correspond to the 1^{th} to the 98^{th} pieces of data, the 99^{th} piece of data, the 100^{th} to the 154^{th} pieces of data, the 155^{th} to the 168^{th} pieces of data and the 169^{th} to the 205^{th} pieces of data, respectively, according to the aforementioned threshold values t_{g}. Moreover, the 1^{th} to the 98^{th} pieces of data correspond to the model code 3, the 99^{th} piece of data corresponds to the model code 13, the 100^{th} to the 154^{th} pieces of data corresponds to the model code 13, the 155^{th} to the 168^{th} pieces of data corresponds to the model code 14, the 169^{th} to the 205^{th} pieces of data corresponds to the model code 5.

The step S04 is performed to calculate the data of the groups by a type of the regression model, which is corresponding to the model code 2212, according to the aforementioned group and the corresponding model code 2212. For example, the model code 3 corresponds to the Linear Regression model, the model code 5 corresponds to the Decision Tree regression model, the model code 13 corresponds to the Ridge Regression model, and the model code 14 corresponds to the Gradient Boosting regression model. The step S04 is performed to analyze the 1^{th} to the 98^{th} pieces of data through the Linear Regression model, analyze the 99^{th} piece of data through the Ridge Regression model, analyze the 100^{th} to the 154^{th} pieces of data through the Ridge Regression model, analyze the 155^{th} to the 168^{th} pieces of data through the Gradient Boosting regression model, and analyze the 169^{th} to the 205^{th} pieces of data through the Decision Tree regression model to generate the predicting result 223 and the fitness value FS thereof. The fitness value FS can be satisfied the following formula (3):

$$F ( X ) = \frac{Max AE ( R ( X ) )}{Max {AE}_{X gboost}} + \frac{MAE ( R ( X ) )}{{MAE}_{Xgboost}} . \qquad ( 3 )$$

F(X) represents the fitness value FS, MaxAE_{Xgboost} represents a maximum absolute error of the dataset when all the data in the dataset are calculated by the XGBoost regression model. MaxAE(R(X)) represents a maximum absolute error of the dataset, when each of the data in the dataset is calculated through the model type of the parameter set 221 corresponding to each of the groups. MAE_{Xgboost} represents an average absolute error of the dataset when all the data in the dataset are calculated by the XGBoost regression model. MAE(R(X)) represents an average absolute error of the dataset, when each of the data in the dataset is calculated through the model type of the parameter set 221 corresponding to each of the groups.

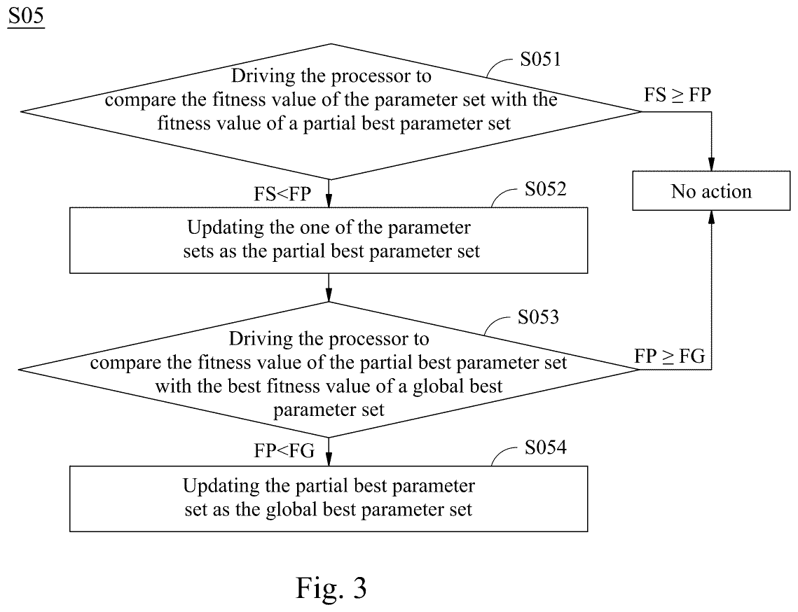

Please refer to FIG. 1 to FIG. 3. FIG. 3 shows a schematic view of the step S05 of updating the best fitness value FG of the optimization method 100 of the regression model of FIG. 1. The step S05 includes steps S051, S052, S053, S054. The step S051 includes driving the processor 220 to compare the fitness value FS of the parameter set 221 with the fitness value FP of a partial best parameter set. The partial best parameter set is a best one of the parameter sets 221 in a present iteration. In response to determining that the fitness value FS of one the parameter sets 221 is less than the fitness value FP of the partial best parameter set, the step S052 is performed to update the one of the parameter sets 221 as the partial best parameter set. The step S053 includes driving the processor 220 to compare the fitness value FP of the partial best parameter set with the best fitness value FG of a global best parameter set. The global best parameter set is a best one of the parameter sets 221, and the global best parameter set has the best fitness value FG. In response to determining that the fitness value FP of the partial best parameter set is less than the best fitness value FG of the global best parameter set, the step S054 is performed to update the partial best parameter set as the global best parameter set.

For instance, a fitness value FS of the present parameter set 221 is 1.5, a fitness value FP of the present partial best parameter set is 1.7, and a best fitness value FG of the present global best parameter set is 1.6. Due to the fitness value FS of the present parameter set 221 is less than the fitness value FP of the partial best parameter set, the present parameter set 221 replaces the partial best parameter set to be a new partial best parameter set. Further, the fitness value FP (i.e., 1.5) of the new partial best parameter set is less than the best fitness value FG (i.e., 1.6) of the global best parameter set, so the parameter set 221 replaces the global best parameter set to be a new global best parameter set.

The step S06 is performed to determine whether a number of the parameter sets 221 is equal to the predetermined value. In other words, the step S06 determines whether the updating time of the parameter set 221 achieves the predetermined updating time, and stop updating when the predetermined updating time is achieved. Thus, the optimization method 100 of the regression model of the present disclosure can reduce the residual of the calculating result of the regression models M1-MN, and increase the predicting accuracy.

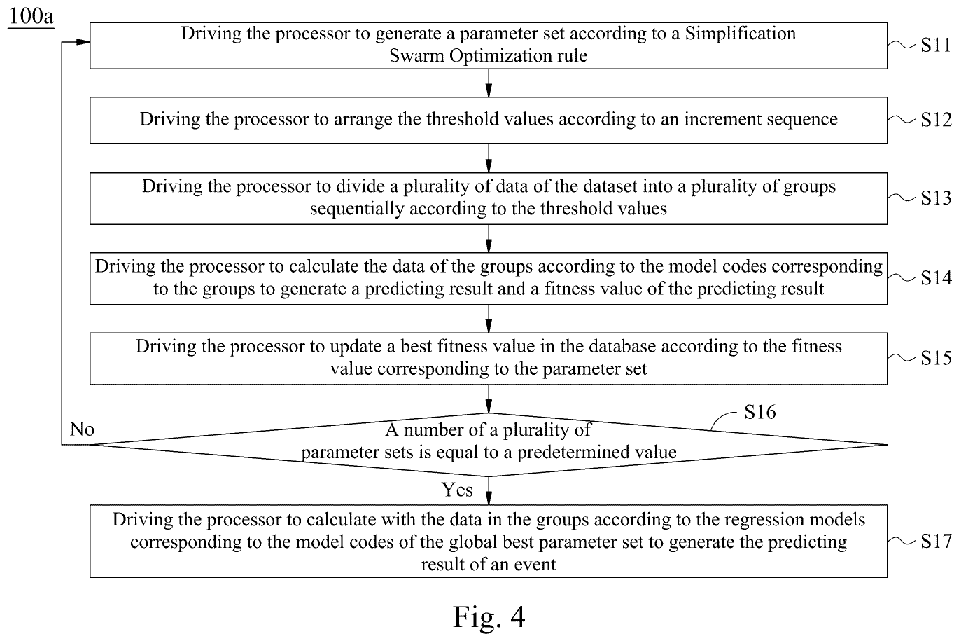

Please refer to FIG. 1, FIG. 2 and FIG. 4. FIG. 4 shows a flow chart of an optimization method 100a of a regression model according to a third embodiment of the present disclosure. The optimization method 100a of the regression model includes steps S11, S12, S13, S14, S15, S16, S17. In the third embodiment, the steps S11, S12, S13, S14, S15, S16 of the optimization method 100a of the regression model can be the same as the steps S01, S02, S03, S04, S05, S06 of the optimization method 100 of the regression model, respectively, and will not be described again. The optimization method 100a of the regression model further includes the step S17. The step S17 includes driving the processor 220 to calculate with the data in the groups according to the regression models M1-MN corresponding to the model codes 2212 of the global best parameter set to generate the predicting result 223 of an event.

In detail, the optimization method 100a of the regression model calculates and generates the parameter set 221, which has the best fitness value FG, through the steps S11-S16, divides the plurality pieces of data of event to-be-predicted into a plurality of groups according to the threshold values 2211 of the parameter set 221 via the step S17, and analyze the groups with different regression models M1-MN according to the model code 2212 of the parameter set 221. Thus, the optimization method 100a of the regression model of the present disclosure can minimize the residual of the regression models M1-MN, predicts the predicting result 223, which has the smallest difference with the actual condition. For example, the optimization method 100a of the regression model of the present disclosure can be applied to disease prediction, path prediction of intelligent probe card or probability of other event, but the present disclosure is not limited thereto. In other embodiments of the present disclosure, the parameters of the global best parameter set calculated by the optimization method of the regression model of the present disclosure are brought into the regression model, a best moving path of the intelligent probe card is predicted by the aforementioned regression model, the intelligent probe card moves along the calculated best moving path, and tests the object to-be-tested. Therefore, the testing efficiency of the production line can be increased, and ensure the yield of the product, but the present disclosure is not limited thereto.

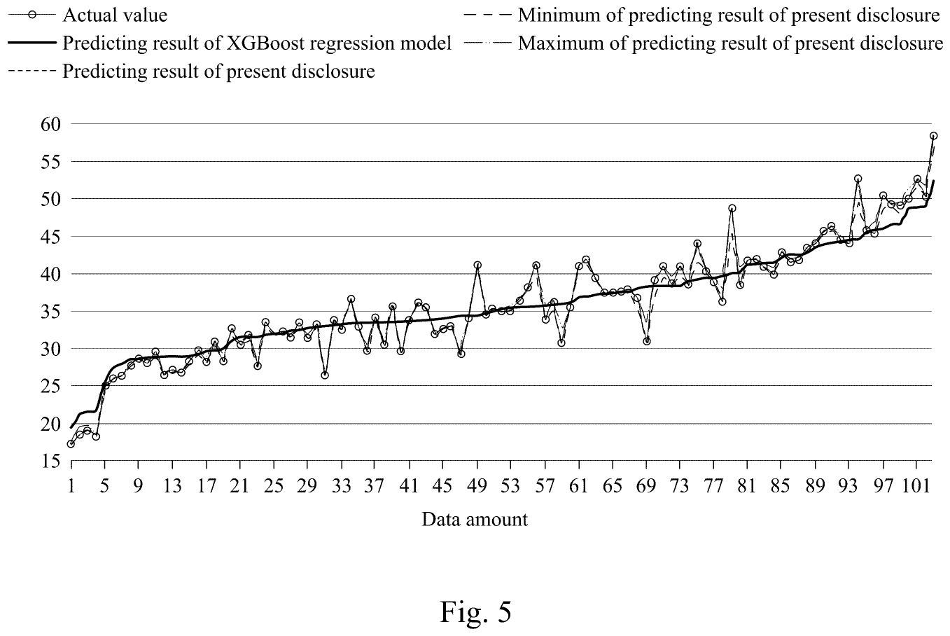

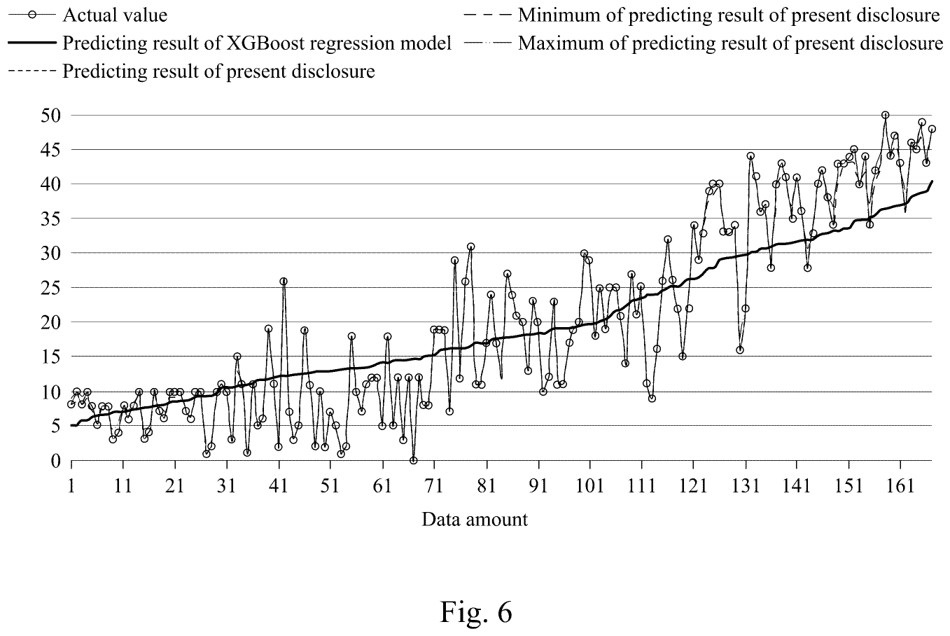

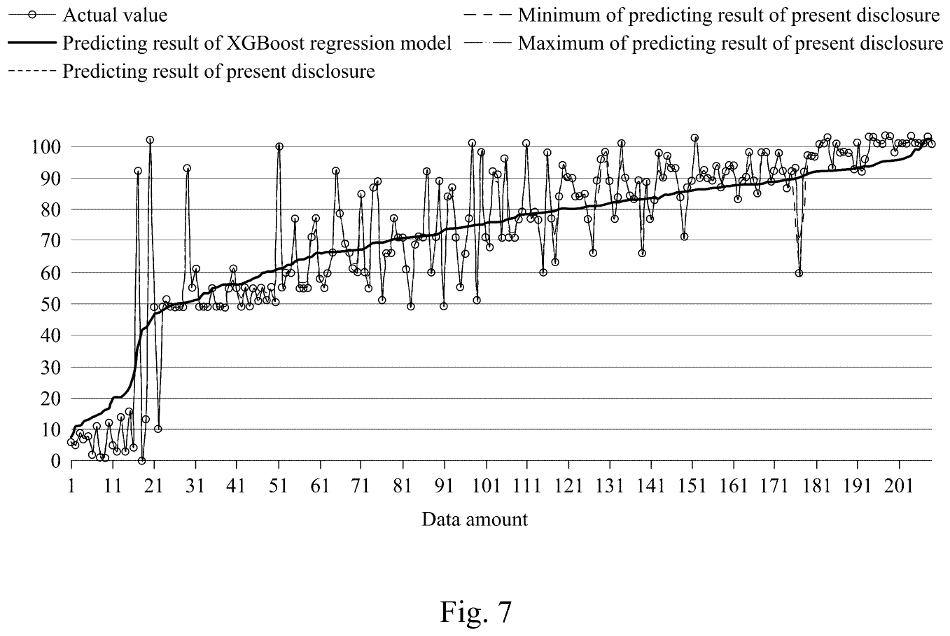

Please refer to FIG. 4 to FIG. 7. FIG. 5 shows a comparative schematic view between an actual value and the predicting result 223 of the optimization method 100a of the regression model of FIG. 4. FIG. 6 shows another comparative schematic view between an actual value and the predicting result 223 of the optimization method 100a of the regression model of FIG. 4. FIG. 7 shows further another comparative schematic view between an actual value and the predicting result 223 of the optimization method 100a of the regression model of FIG. 4. In FIGS. 5-7, the comparison between the predicting results 223 of the optimization method 100a of the regression model of the present disclosure and the predicting results of the conventional XGBoost regression model by predicting with the concrete slump test dataset, the servo dataset and the CPU performance dataset in the UCI machine learning database. Moreover, FIGS. 5-7 further show a maximum value and a minimum value of the predicting result 223 of the optimization method 100a of the regression model of the present disclosure. Furthermore, the units of the vertical axis are not shown in FIGS. 5-7, the vertical axis are only for showing the trend and the gap between the predicting result 223 and the actual value.

Please refer to Table 2, Table 2 lists the data amount, number of feature of the concrete slump test dataset, servo dataset and CPU performance dataset and the maximum absolute error, the average absolute error, the fitness value and the runtime, which are predicted by the XGBoost regression model and the optimization method 100a of the regression model of the present disclosure.

In FIGS. 5-7 and Table 2, the actual values in the aforementioned three datasets have obvious fluctuations, and the fluctuations become more obvious when the data amount increase. The predicting result generated by the XGBoost regression model shows a smoother increment than the actual value, and the predicting result 223 of the optimization method 100a of the regression model of the present disclosure is closer to the actual value than the predicting value of the XGBoost regression model. Thus, the optimization method 100a of the regression model of the present disclosure can select suitable regression models M1-MN to calculate and train with different data samples to let the predicting result 223 close to the actual value.

TABLE 2

| | | concrete | servo | CPU |
|---|---|---|---|---|
| dataset | | slump test | data | performance |
| data amount | | 103 | 167 | 209 |
| number of feature | | 7 | 4 | 9 |
| XGBoost | maximum absolute error | 8.705 | 14.95 | 57.52 |
| regression model | average absolute error | 1.913 | 5.58 | 8.608 |
| the optimization | fitness value | 0.120 | 0.055 | 0.024 |
| method 100a of the | maximum absolute error | 0.687 | 0.687 | 0.895 |
| regression model | average absolute error | 0.07 | 0.052 | 0.075 |
| of the present | maximum absolute error (%) | 7.8% | 4.5% | 1.55% |
| disclosure | average absolute error (%) | 4.1% | 0.9% | 0.87% |
| | runtime | 204.9 | 433.4 | 592.2 |

According to the aforementioned embodiments and examples, the advantages of the present disclosure are described as follows.
1. The optimization method of the regression model of the present disclosure can reduce the residual of the calculating result of the regression models, and increase the predicting accuracy.
2. The optimization method of the regression model of the present disclosure can minimize the residual of the regression models, predicts the predicting result, which has the smallest difference with the actual condition.
3. The optimization method of the regression model of the present disclosure can select suitable regression models to calculate and train with different data samples to let the predicting result close to the actual value.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An optimization method of a regression model, comprising:
driving a processor to generate a parameter set according to a Simplification Swarm Optimization rule, wherein the parameter set comprises a plurality of threshold values and a plurality of model codes, the model codes correspond to a plurality of the regression models, and a plurality of types of the regression models are different from each other;
driving the processor to arrange the threshold values according to an increment sequence;
driving the processor to divide a plurality of data of a dataset into a plurality of groups sequentially according to the threshold values, wherein the groups correspond to the model codes, respectively;
driving the processor to calculate the data of the groups according to the model codes corresponding to the groups to generate a predicting result and a fitness value of the predicting result;
driving the processor to update a best fitness value in a database according to the fitness value corresponding to the parameter set; and
driving the processor to repeat the above steps until a number of a plurality of the parameter sets being equal to a predetermined value.

2. The optimization method of the regression model of claim 1, wherein the regression models comprise one of a Linear Regression model, a Ridge Regression model, a Least Absolute Shrinkage and Selection Operator (LASSO) regression model, a Decision Tree regression model, a Gradient Boosting regression model, a random forest regression model, an Adaptive Boosting regression model, a Bagging regression model, an Extra Trees regression model, an extreme Gradient Boosting (XGBoost) regression model, a Support Vector Regression (SVR) model, a Nu-SVR regression model, a Linear SVM model, a K-nearest Neighbors regression model and an Artificial Neural Network (ANN).

3. The optimization method of the regression model of claim 1, wherein the Simplification Swarm Optimization rule is satisfied the following condition:
$${t}_{i , j} = \{ \begin{matrix}{g}_{t , j} , if {ρ}_{t , j} ∈ [ 0 , {C}_{g} ) \\ {p}_{t , i , j} , if {ρ}_{t , j} ∈ [ {C}_{g} , {C}_{p} ) \\ {t}_{i , j} , if {ρ}_{t , j} ∈ [ {C}_{p} , {C}_{w} ) \\ t , if {ρ}_{t , j} ∈ [ {C}_{w} , 1 ]\end{matrix} ; and$$
$${m}_{i , j} = \{ \begin{matrix}{g}_{m , j} , if {ρ}_{m , j} ∈ [ 0 , {C}_{g} ) \\ {p}_{m , i , j} , if {ρ}_{m , j} ∈ [ {C}_{g} , {C}_{p} ) \\ {m}_{m , j} , if {ρ}_{m , j} ∈ [ {C}_{p} , {C}_{w} ) \\ m , if {ρ}_{m , j} ∈ [ {C}_{w} , 1 ]\end{matrix} ;$$
wherein t_{i,j} is a j-th threshold value of an i-th parameter set, g_{t,j} is a j-th threshold value of a global best parameter set, p_{t,i,j} is a j-th threshold value of a partial best parameter set, t is a random value, β_{t,j} and β_{m,j} are two random parameters between 0 and 1, C_{g}, Cₚ, C_{w} are a first parameter, a second parameter and a third parameter, respectively, m_{i,j} is a j-th model code of the i-th parameter set, g_{m,j} is a j-th model code of the global best parameter set, p_{m,i,j} is a j-th model code of the partial best parameter set, m is another random value.

4. The optimization method of the regression model of claim 1, wherein,
driving the processor to compare the fitness value of one of the parameter sets with the fitness value of a partial best parameter set, wherein the partial best parameter set is a best one of the parameter sets in a present iteration;
wherein in response to determining that the fitness value of the one the parameter sets is less than the fitness value of the partial best parameter set, the one of the parameter sets is updated as the partial best parameter set; and
driving the processor to compare the fitness value of the partial best parameter set with the best fitness value of a global best parameter set, wherein the global best parameter set is a best one of the parameter sets, and the global best parameter set has the best fitness value;
wherein in response to determining that the fitness value of the partial best parameter set is less than the best fitness value of the global best parameter set, the partial best parameter set is updated as the global best parameter set.

5. The optimization method of the regression model of claim 4, further comprising:
driving the processor to calculate with the data in the groups according to the regression models corresponding to the model codes of the global best parameter set to generate the predicting result of an event.

6. An optimization system of a regression model, comprising:
a database comprising a Simplification Swarm Optimization rule, a plurality of the regression models, a dataset and a best fitness value; and
a processor signally connected to the database, and configured to implement an optimization method of the regression model, comprising:
generating a parameter set according to the Simplification Swarm Optimization rule, wherein the parameter set comprises a plurality of threshold values and a plurality of model codes, the model codes correspond to the regression models, and a plurality of types of the regression models are different from each other;
arranging the threshold values according to an increment sequence;
dividing a plurality of data of the dataset into a plurality of groups sequentially according to the threshold values, wherein the groups correspond to the model codes, respectively;
calculating the data of the groups according to the model codes corresponding to the groups to generate a predicting result and a fitness value of the predicting result;
updating the best fitness value according to the fitness value corresponding to the parameter set; and
repeating the above steps until a number of a plurality of the parameter sets being equal to a predetermined value.

7. The optimization system of the regression model of claim 6, wherein the regression models comprise one of a Linear Regression model, a Ridge Regression model, a Least Absolute Shrinkage and Selection Operator regression model, a Decision Tree regression model, a Gradient Boosting regression model, a random forest regression model, an Adaptive Boosting regression model, a Bagging regression model, an Extra Trees regression model, an extreme Gradient Boosting regression model, a Support Vector Regression model, a Nu-SVR regression model, a Linear SVM model, a K-nearest Neighbors regression model and an Artificial Neural Network.

8. The optimization system of the regression model of claim 6, wherein the Simplification Swarm Optimization rule is satisfied the following condition:
$${t}_{i , j} = \{ \begin{matrix}{g}_{t , j} , if {ρ}_{t , j} ∈ [ 0 , {C}_{g} ) \\ {p}_{t , i , j} , if {ρ}_{t , j} ∈ [ {C}_{g} , {C}_{p} ) \\ {t}_{i , j} , if {ρ}_{t , j} ∈ [ {C}_{p} , {C}_{w} ) \\ t , if {ρ}_{t , j} ∈ [ {C}_{w} , 1 ]\end{matrix} ; and$$
$${m}_{i , j} = \{ \begin{matrix}{g}_{m , j} , if {ρ}_{m , j} ∈ [ 0 , {C}_{g} ) \\ {p}_{m , i , j} , if {ρ}_{m , j} ∈ [ {C}_{g} , {C}_{p} ) \\ {m}_{m , j} , if {ρ}_{m , j} ∈ [ {C}_{p} , {C}_{w} ) \\ m , if {ρ}_{m , j} ∈ [ {C}_{w} , 1 ]\end{matrix} ;$$
wherein t_{i,j} is a j-th threshold value of an i-th parameter set, g_{t,j} is a j-th threshold value of a global best parameter set, p_{t,i,j} is a j-th threshold value of a partial best parameter set, t is a random value, β_{t,j} and ρ_{m,j} are two random parameters between 0 and 1, C_{g}, Cₚ, C_{w} are a first parameter, a second parameter and a third parameter, respectively, m_{i,j} is a j-th model code of the i-th parameter set, g_{m,j} is a j-th model code of the global best parameter set, p_{m,i,j} is a j-th model code of the partial best parameter set, m is another random value.

9. The optimization system of the regression model of claim 6, wherein,
comparing the fitness value of one of the parameter sets with the fitness value of a partial best parameter set, wherein the partial best parameter set is a best one of the parameter sets in a present iteration;
wherein in response to determining that the fitness value of the one the parameter sets is less than the fitness value of the partial best parameter set, the one of the parameter sets is updated as the partial best parameter set; and
comparing the fitness value of the partial best parameter set with the best fitness value of a global best parameter set, wherein the global best parameter set is a best one of the parameter sets, and the global best parameter set has the best fitness value;
wherein in response to determining that the fitness value of the partial best parameter set is less than the best fitness value of the global best parameter set, the partial best parameter set is updated as the global best parameter set.

10. The optimization system of the regression model of claim 9, wherein the optimization method of the regression model further comprises:
calculating with the data in the groups according to the regression models corresponding to the model codes of the global best parameter set to generate the predicting result of an event.

11. A computer readable recording medium storing a program for a processor, to execute an optimization method of a regression model comprising:
driving the processor to generate a parameter set according to a Simplification Swarm Optimization rule, wherein the parameter set comprises a plurality of threshold values and a plurality of model codes, the model codes correspond to a plurality of the regression models, and a plurality of types of the regression models are different from each other;
driving the processor to arrange the threshold values according to an increment sequence;
driving the processor to divide a plurality of data of a dataset into a plurality of groups sequentially according to the threshold values, wherein the groups correspond to the model codes, respectively;
driving the processor to calculate the data of the groups according to the model codes corresponding to the groups to generate a predicting result and a fitness value of the predicting result;
driving the processor to update a best fitness value in a database according to the fitness value corresponding to the parameter set; and
driving the processor to repeat the above steps until a number of a plurality of the parameter sets being equal to a predetermined value.

12. The computer readable recording medium of claim 11, wherein the regression models comprise one of a Linear Regression model, a Ridge Regression model, a Least Absolute Shrinkage and Selection Operator regression model, a Decision Tree regression model, a Gradient Boosting regression model, a random forest regression model, an Adaptive Boosting regression model, a Bagging regression model, an Extra Trees regression model, an extreme Gradient Boosting regression model, a Support Vector Regression model, a Nu-SVR regression model, a Linear SVM model, a K-nearest Neighbors regression model and an Artificial Neural Network.

13. The computer readable recording medium of claim 11, wherein the Simplification Swarm Optimization rule is satisfied the following condition:
$${t}_{i , j} = \{ \begin{matrix}{g}_{t , j} , if {ρ}_{t , j} ∈ [ 0 , {C}_{g} ) \\ {p}_{t , i , j} , if {ρ}_{t , j} ∈ [ {C}_{g} , {C}_{p} ) \\ {t}_{i , j} , if {ρ}_{t , j} ∈ [ {C}_{p} , {C}_{w} ) \\ t , if {ρ}_{t , j} ∈ [ {C}_{w} , 1 ]\end{matrix} ; and$$
$${m}_{i , j} = \{ \begin{matrix}{g}_{m , j} , if {ρ}_{m , j} ∈ [ 0 , {C}_{g} ) \\ {p}_{m , i , j} , if {ρ}_{m , j} ∈ [ {C}_{g} , {C}_{p} ) \\ {m}_{m , j} , if {ρ}_{m , j} ∈ [ {C}_{p} , {C}_{w} ) \\ m , if {ρ}_{m , j} ∈ [ {C}_{w} , 1 ]\end{matrix} ;$$
wherein t_{i,j} is a j-th threshold value of an i-th parameter set, g_{t,j} is a j-th threshold value of a global best parameter set, p_{t,i,j} is a j-th threshold value of a partial best parameter set, t is a random value, β_{t,j} and μ_{m,j} are two random parameters between 0 and 1, C_{g}, Cₚ, C_{w} are a first parameter, a second parameter and a third parameter, respectively, m_{i,j} is a j-th model code of the i-th parameter set, g_{m,j} is a j-th model code of the global best parameter set, p_{m,i,j} is a j-th model code of the partial best parameter set, m is another random value.

14. The computer readable recording medium of claim 11, wherein,
driving the processor to compare the fitness value of one the parameter sets with the fitness value of a partial best parameter set, wherein the partial best parameter set is a best one of the parameter sets in a present iteration;
wherein in response to determining that the fitness value of the one the parameter sets is less than the fitness value of the partial best parameter set, the one of the parameter sets is updated as the partial best parameter set; and
driving the processor to compare the fitness value of the partial best parameter set with the best fitness value of a global best parameter set, wherein the global best parameter set is a best one of the parameter sets, and the global best parameter set has the best fitness value;
wherein in response to determining that the fitness value of the partial best parameter set is less than the best fitness value of the global best parameter set, the partial best parameter set is updated as the global best parameter set.

15. The computer readable recording medium of claim 14, the optimization method of the regression model further comprises:
driving the processor to calculate with the data in the groups according to the regression models corresponding to the model codes of the global best parameter set to generate the predicting result of an event.
